(19) United States
(12) Patent Application Publication
(10) Pub. No.: US 2008/0184613 A1
(43) Pub. Date: Aug. 7, 2008

(54) Trap

(76) Inventor: Joseph Emery Finnigan, Coquitlam (CA)

Correspondence Address: NORMAN M. CAMERON, SUITE 1401 - 1166 ALBERNI STREET, VANCOUVER, BC, V6E 3Z3, omitted

(21) Appl. No.: 11/703,097

(22) Filed: Feb. 7, 2007

(51) Int. Cl. A01M 23/08

(52) U.S. Cl. 43/66; 43/65; 43/61

(57) ABSTRACT

A trap comprises an enclosure having an opening and a door for closing the opening. The door has a first portion operatively connected to the enclosure and a second portion extending into the enclosure. The second portion of the door has a surface able to support a body of an animal.

### BACKGROUND OF THE INVENTION

The present invention relates to a trap, and in particular, to a containment type trap suitable for trapping mice or other rodents.

Areas such as homes, restaurants, and stores typically support a plentiful food supply. This causes mice to infest the aforementioned areas. The infestation may lead to the destruction of property and the spread of disease. It is therefore desirable to trap the infesting mice and properly dispose of them. In this connection, numerous containment type traps have been developed to apprehend and contain mice until they can be properly disposed of.

Conventional containment type traps include an enclosure with a locking door. Typically, a mouse triggers a locking mechanism when it enters the enclosure through the door. The locking mechanism prevents the door from being opened, trapping the mouse in the enclosure. However, conventional containment type traps are generally limited to trapping one mouse at a time because, once the locking mechanism has been engaged the door can no longer be opened, preventing a second mouse from entering the trap.

The present invention provides a containment type trap with a novel door that allows multiple mice to enter the trap through the same door.

### SUMMARY OF THE INVENTION

According to one aspect of the invention there is provided a trap for trapping an animal. The trap comprises an enclosure having an opening and a door for closing the opening. The door has a first portion operatively connected to the enclosure and a second portion extending into the enclosure. The second portion of the door has a surface able to support a body of the animal.

According to another aspect of the invention there is provided a trap for trapping an animal. The animal has front legs and hind legs. The trap comprises an enclosure having an opening and a door for closing the opening. The door has a first portion and a second portion. The first portion of the door has an upper edge and a lower edge. The upper edge is operatively connected to the enclosure. The second portion of the door extends from the lower edge of the first portion of the door and into the enclosure. When the door is in a closed position the second portion of the door is aligned along a plane juxtaposed to a floor of the enclosure. When the door is in the closed position, the second portion of the door extending sufficiently into the enclosure so that when the animal's front legs are in contact with the first portion of the door, the animal's hind legs rest on the second portion of the door. The animal is thereby prevented from opening the door from inside the enclosure.

### BRIEF DESCRIPTION OF THE DRAWING

Referring to the drawings:

FIG. 1 is an elevational, longitudinal cross-sectional view of a trap according to an embodiment to the invention;

FIG. 2 is a fragmentary, cross-sectional view of the trap of FIG. 1 showing an end of the enclosure in greater detail;

FIG. 3 is an elevational end view of the trap of FIG. 1 showing a door in a closed position;

FIG. 4 is a perspective end view of the trap of FIG. 1 showing the door in an open position;

FIG. 5 is a perspective end view of the trap of FIG. 1 showing an animal entering the trap; and

FIG. 6 is an elevational, longitudinal cross-sectional view of the trap of FIG. 1 showing the animal in the trap.

### DETAILED DESCRIPTION OF THE PREFERRED EMBODIMENT

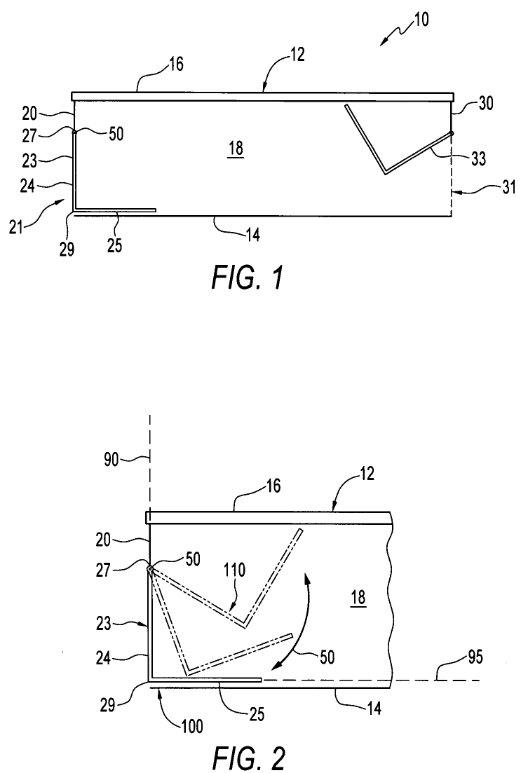

Referring to the drawings and first to FIG. 1, this shows a trap 10 according to an embodiment of the invention. The trap 10 includes an elongated enclosure 12 having a floor 14, a roof 16, and a pair of opposed elongated side walls 18, only one of which is shown in FIG. 1. There is an opening 21, and a door 23 for closing the opening 21, at a first end 20 of the enclosure 12. The door 23 has a first portion 24 and a second portion 25. In a preferred embodiment of the invention, a surface area of the second portion 25 of the door 23 is equal to or greater than a surface area of the first portion 24 of the door. The first portion 24 of the door 23 has an upper edge 27 and a lower edge 29. There is also an opening 31, and a door 33 for closing the opening 31, at a second end 30 of the enclosure 12. The door 23 at the first end 20 of the enclosure 12 is shown in a closed position. The door 33 at the second end 30 of the enclosure 12 is shown in an open position.

The doors 23 and 33 are substantially identical. Therefore, although the following discussion is limited to the door 23 at the first end 20 of the enclosure 12, it is substantially applicable to the door 33 at the second end 30 of the enclosure 12.

As best shown in FIG. 2, the upper edge 27 of the first portion 24 of the door 23 is operatively connected to the first end 20 of the enclosure 12. In this example, the door 23 is pivotably connected to the enclosure 12 by a pin 50. The second portion 25 of the door 23 extends perpendicularly from the lower edge 29 of the first portion 24 of the door 23 and into the enclosure 12. The door 23 can pivot between the closed position at a first extreme 100 and the open position at a second extreme 110. The door 23 pivots as indicated by arrows 50.

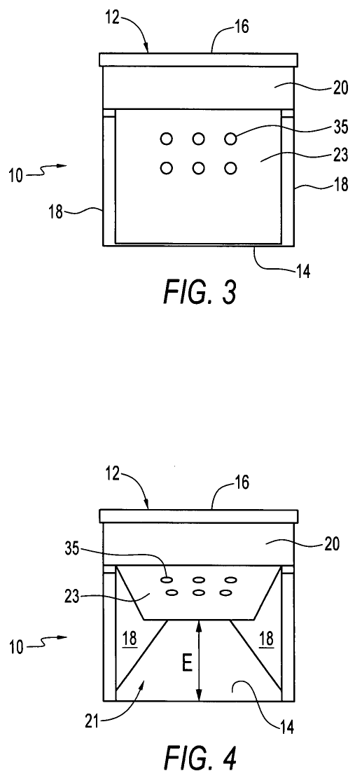

As shown in FIG. 2, in the closed position, the door 23 is in an L-shaped configuration when viewed from the side. The first portion 24 of the door 23 is aligned along a vertical plane 90 that is substantially co-planar with the first end 20 of the enclosure 12. The second portion 25 of the door 23 is aligned along a horizontal plane 95 that is juxtaposed to the floor 14 of the enclosure 12. FIG. 3 shows an end view of the trap 10 with the door 23 in the closed position. There is a plurality of apertures 35 extending through the door 23.

Referring back to FIG. 2, in the open position, the door 23 is in a substantially V-shaped configuration when viewed from the side. The first portion 24 of the door 23 extends angularly downward and into the enclosure 12. The lower edge 29 of the first portion 24 of the door 23 is disposed within the enclosure 12 and spaced-apart from the floor 14 of the enclosure 12. The second portion 25 of the door 23 extends from the lower edge 29 of the first portion 24 of the door 23 angularly upward and further into the enclosure 12. When the door 23 is in the open position, an entrance E, shown in FIG. 4, is defined between the lower edge 29 of the first portion 24 of the door 23 and the floor 14 of the enclosure 12.

The trap 10 is preferably at least partially translucent to allow a user to easily detect if an animal has been trapped.

In operation, the trap 10 functions as follows:—

An animal lure 50, shown in FIG. 6, is placed in the trap 10 and the doors 23 and 33 are closed. The lure 50 is preferably an odoriferous material that is attractive to an animal 70 being trapped. For example, if mice are being trapped, the lure 50 may be a portion of cheese. The animal 70 is attracted to the trap 10 by the scent of the lure 50 emanating from the trap 10. The scent of the lure 50 may emanate through the apertures 35 in the door 23.

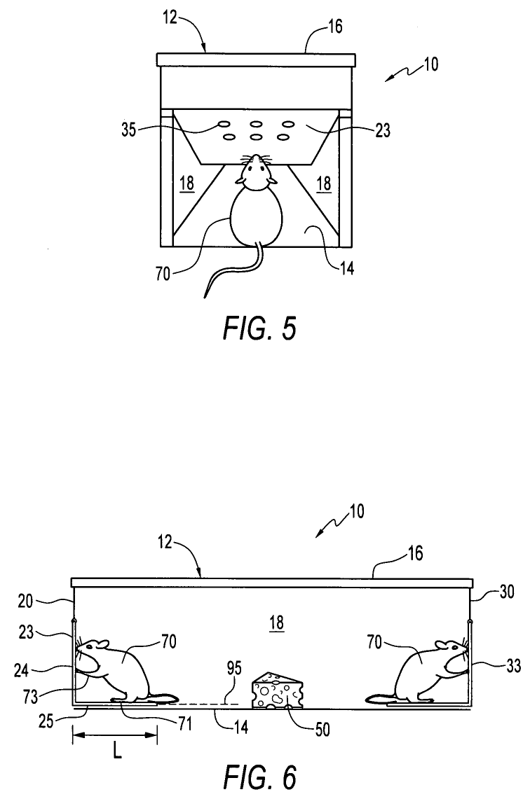

As best shown in FIG. 5, the animal 70 is able to pivot the door 23 from the closed position to the open position by pushing against the first portion 24 of the door 23. When the door 23 is in the open position, the animal 70 is able to enter the trap through the entrance E, shown in FIG. 4, to access the lure 50. After the animal 70 enters the trap 10 through the entrance E, the door 23 pivots back to the closed position under its own weight. Once inside the trap, the animal 70 is unable to pivot the door 23 from the closed position to the open position and the animal is trapped.

As best shown in FIG. 6, when the door 23 is in the closed position, the second portion 25 of the door 23 extends into the enclosure 12. The second portion of the door 23 is aligned along a horizontal plane 95 that is juxtaposed to the floor 14 of the enclosure 12. The second portion 25 of the door 23 extends sufficiently into the enclosure 12 so that when the animal's front legs 71 are in contact with the first portion 24 of the door 23 the animal's hind legs 73 rest on the second portion 25 of the door 23. The second portion 25 of the door 23 has as surface area that supports that animal's body. Since the animal 70 has no external platform to push against to open the door 23. The animal's own body weight acts as an anchor preventing the animal 70 from pivoting the door 23 to the open position. The animal's body weight is a locking mechanism.

Although the animal 70 inside the trap 10 cannot move the door 23 from the closed position to the open position, a second animal (not shown) outside the trap 10 is able to move the door 23 from the closed position to the open position and enter the trap 10, provided the animal 70 inside the trap 10 is not on the second portion 25 of the door 23. It is therefore possible for multiple animals to enter the trap 10 through the same door 23. Alternatively, animals may enter the trap through another door such as the door 33 at the second end of the enclosure 12.

It will be understood by someone skilled in the art that many of the details provided above are by way of example only and are not intended to limit the scope of the invention which is to be determined with reference to the following claims. For example the doors and door portions may be staged and configured differently than illustrated in the drawings.

What is claimed is:

1. A trap for trapping a desired animal, the trap comprising:
an enclosure having an opening; and
a door for closing the opening, the door having a first portion operatively connected to the enclosure and a second portion extending into the enclosure, the second portion of the door having a surface area able to support a body of the animal.

2. The trap as claimed in claim 1, wherein the first portion of the door has an upper edge, the upper edge being pivotably connected to the enclosure.

3. The trap as claimed in claim 1, wherein the first portion of the door as a lower edge, the second portion of the door extending from the lower edge and into the enclosure.

4. The trap as claimed in claim 1, wherein the second portion of the door is angularly spaced apart from the first portion of the door.

5. The trap as claimed in claim 1, wherein the second portion of the door is aligned along a plane juxtaposed to a floor of the enclosure when the door is in a closed position.

6. The trap as claimed in claim 1, wherein the surface area of the second portion of the door is equal to a surface area of the first portion of the door.

7. The trap as claimed in claim 1, wherein a surface area of the second portion of the door is greater than a surface area of the first portion of the door.

8. The trap as claimed in claim 1, wherein the enclosure is an elongate enclosure.

9. The trap as claimed in claim 8, wherein the door is located at an end of the enclosure.

10. The trap as claimed in claim 1, further including an animal lure therein.

11. A trap for trapping a desired animal, the trap comprising:
an enclosure having an opening; and
a door for closing the opening, the door having a first portion and a second portion, the first portion of the door having an upper edge and a lower edge, the upper edge of the first portion of the door being pivotably connected to the enclosure, the second portion of the door extending from the lower edge of the first portion of the door and into the enclosure, a surface area of the second portion of the door able to support a body of the animal.

12. The trap as claimed in claim 11, wherein the second portion of the door is angularly spaced apart from the first portion of the door.

13. The trap as claimed in claim 11, wherein the second portion of the door is aligned along a plane juxtaposed to a floor of the enclosure when the door is in a closed position.

14. The trap as claimed in claim 11, wherein the surface area of the second portion of the door is equal to a surface area of the first portion of the door.

15. The trap as claimed in claim 11, wherein the surface area of the second portion of the door is greater than a surface area of the first portion of the door.

16. The trap as claimed in claim 11, wherein the door is located at an end of the enclosure.

17. The trap as claimed in claim 11, further including an animal lure therein.

18. A trap for trapping a desired animal, the animal having front legs and hind legs, the trap comprising:
an enclosure having opening; and
a door for closing the opening, the door having a first portion and a second portion, the first portion of the door having an upper edge and a lower edge, the upper edge of the first portion of the door being operatively connected to the enclosure, the second portion of the door extending from the lower edge of the first portion of the door and into the enclosure along a plane juxtaposed to a floor of the enclosure when the door is in a closed position, when the door is in the closed position the second portion of the door extending sufficiently into the enclosure so that when the animal's front legs are in contact with the first portion of the door the animal's hind legs rest on the second portion of the door, thereby preventing the animal from opening the door from inside the enclosure.

19. The trap as claimed in claim 18, wherein the first portion is pivotably connected to the enclosure.

20. The trap as claimed in claim 18, further including an animal lure therein.
